(19) United States
(12) Patent Application Publication
(10) Pub. No.: US 2022/0138356 A1
(43) Pub. Date: May 5, 2022

(54) ACCESS REGULATION OF PERIPHERAL DEVICES

(71) Applicant: Hewlett-Packard Development Company, L.P., Spring, TX (US)

(72) Inventors: Endrigo Nadin Pinheiro, Spring, TX (US); Mason Gunyuzlu, Spring, TX (US); Robert Craig, Spring, CA (US)

(73) Assignee: Hewlett-Packard Development Company, L.P., Spring, TX (US)

(21) Appl. No.: 17/293,285

(22) PCT Filed: Jul. 24, 2019
(86) PCT No.: PCT/US2019/043225

§ 371 Date: May 12, 2021

(51) Int. Cl. G06F 21/83; G06F 21/44

(52) U.S. Cl. CPC G06F 21/83; G06F 21/44

(57) ABSTRACT

In an example, an apparatus for access regulation of peripheral devices may include a processor and a communication interface to communicate to a peripheral device and to the processor. The processor may identify a pattern associated with receiving input data from a first peripheral device, wherein the pattern includes a keystroke rate, a delay in a keystroke pattern, a keystroke pressure, or a combination thereof. Similarly, the processor may, in response to detecting enumeration of a second peripheral device coupled to the apparatus, compare particular input data received from the second peripheral device with the pattern, and regulate access of the second peripheral device to the apparatus, based on the comparison.

### BACKGROUND

Once a host computing device discovers a new peripheral device, the host may send requests to establish a direct communication path between the host and the peripheral device. From there, the host may attempt to enumerate the peripheral device by issuing control transfers that contain various requests to the device. During enumeration, the host may select a configuration for the peripheral device using device drivers.

### BRIEF DESCRIPTION OF FIGURES

Various examples may be more completely understood in consideration of the following detailed description in connection with the accompanying drawings, in which:

FIG. 1 illustrates an example apparatus for access regulation of peripheral devices, consistent with the present disclosure;

FIG. 2 illustrates a block diagram of an example computing apparatus including instructions for access regulation of peripheral devices, consistent with the present disclosure; and

FIG. 3 illustrates a block diagram of an example computing apparatus including instructions for access regulation of peripheral devices, consistent with the present disclosure.

### DETAILED DESCRIPTION

An increasing number of devices are being designed to communicate in either a wired or wireless manner with other electronic devices. As an illustration, universal serial bus (USB) compliant devices such as human interface devices, mass storage devices, audio devices, video devices, communication devices, and printers, among others, may be provided with corresponding abilities to communicate with other types of USB devices. In any case, device enumeration may be utilized to connect the host device to a peripheral device. As discussed herein, enumeration may include the transmission of information between the peripheral device and computing apparatus in order for the drivers for the peripheral devices to install. During enumeration, various configurations are established to allow the host device to communicate with the peripheral device. The enumeration process may include a number of operations to configure the peripheral device.

With the increase in usage of peripheral devices, it may be possible to connect a malicious peripheral device to a host computing device, and attempt to inject mouse and keyboard data into the host computing device to modify and take control. Further, speed and patterns of typing and clicking across different users may complicate efforts to discern between actual user input data from a peripheral device such as a keyboard or mouse, and input data generated by a malicious device.

In various examples, an apparatus for access regulation of peripheral devices may include a processor and a communication interface to communicate to a peripheral device and to the processor. The processor may identify a pattern associated with receiving input data from a first peripheral device, where the pattern includes a keystroke rate, a delay in a keystroke pattern, a keystroke pressure, or a combination thereof. Similarly, the processor may, in response to detecting enumeration of a second peripheral device coupled to the apparatus, compare particular input data received from the second peripheral device with the pattern, and regulate access of the second peripheral device to the apparatus, based on the comparison.

In various examples, a non-transitory computer-readable storage medium may include instructions that when executed by a processor of a computing device, cause the processor to generate a user interaction profile including a feature representative of a manner in which first input data from a first peripheral device of the computing device is received. The processor may detect enumeration of a second peripheral device coupled to the computing device, and collect second input data from the second peripheral device. The second input data may include a second feature representative of a manner in which the second input data is received from the second peripheral device. Moreover; the processor may generate an anomaly score based on a comparison of the second input data and the user interaction profile, and regulate input of the second peripheral device based on the anomaly score.

In an additional example, a non-transitory computer-readable storage medium includes instructions that when executed by a processor of a computing device, cause the processor to collect first input data from a first peripheral device coupled to the computing device, where the first input data includes a feature representative of a manner in which first input data from the first peripheral device is received. The processor may generate a user interaction profile including the feature, and collect second input data from a second peripheral device coupled to the computing device. The second input data may include a second feature representative of a manner in which the second input data is received from the second peripheral device. Moreover, the processor may, based on a comparison of the second input data and the user interaction profile, regulate access of the second peripheral device to the computing device, and provide selectable options on a graphical user interface of the computing device to override regulated access of the second peripheral device. Accordingly, the processor can cancel input received from peripheral devices that are suspected of being malicious, thereby avoiding modification of the host computing device.

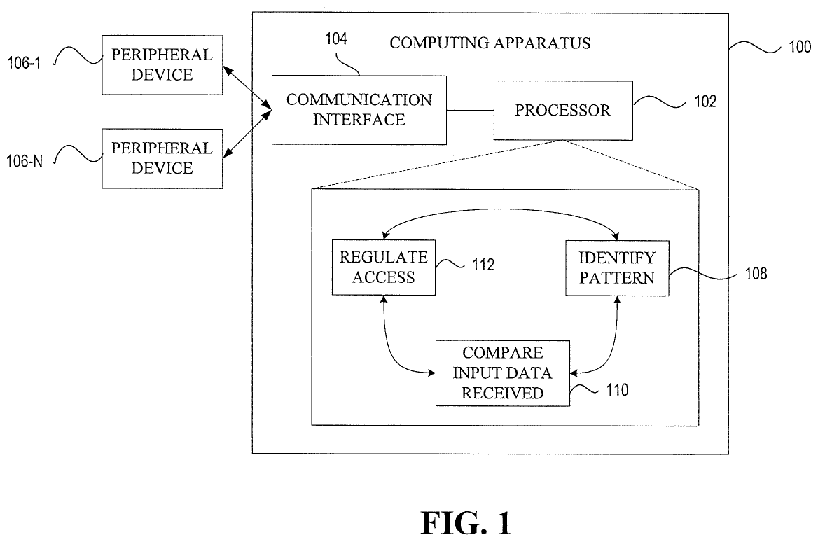

Turning now to the figures, FIG. 1 illustrates an example apparatus 100 for access regulation of peripheral devices, consistent with the present disclosure. The apparatus 100 may include a processor 102, and a communication interface 104. The communication interface 104 may communicate to a peripheral device and to the processor 102. For instance, the communication interface 104 may communicate to and/or from peripheral devices 106-1, 106-N, referred to collectively as peripheral devices 106. Although aspects and features may in some cases be described in individual figures, it will be appreciated that features from one figure or example can be combined with features of another figure or example even though the combination is not explicitly shown or explicitly described as a combination. As such, FIG. 1 may include more or fewer aspects than those illustrated. Additionally, the functional blocks in FIG. 1 may be circuits configured or coded by design and/or by configurable circuitry such as Central Process Units (CPUs), logic arrays, and/or controllers, for carrying out such operational aspects.

In various examples, the processor 102 may regulate access of a peripheral device among the peripheral devices 106. For instance, at 108, the processor 102 may identify a pattern associated with receiving input data from a first peripheral device 106-1. As used herein, the pattern refers to or includes a feature associated with use of an interactive peripheral device, such as a keyboard, a mouse, a joystick, and/or a biometric sensor, among others. Example patterns may include a keystroke rate, a delay in a keystroke pattern, and/or a keystroke pressure, among other example patterns. In response to detecting enumeration of a second peripheral device 106-N coupled to the apparatus 100, the processor 102 may compare particular input data received from the second peripheral device 106-N with the pattern, at 110. At 112, the processor 102 may regulate access of the second peripheral device 106-N to the apparatus 100, based on the comparison. Where reference is made to a “first peripheral device”, a “second peripheral device”, etc., the adjectives “first” and “second” are not used to connote any description of the structure or to provide any substantive meaning; rather, such adjectives are merely used to differentiate one circuit from another similarly-named circuit.

As an illustration, the first peripheral device 106-1 may include a keyboard. In such examples, the delay in the keystroke pattern may include a length of time between press and release of each respective key on the keyboard, sometimes referred to as a hold time. As an additional example, the pattern may include an amount of elapsed time between depression of a first key on the keyboard and depression of a second key on the keyboard, sometimes referred to as a keydown-keydown time. Further examples of a pattern may include an amount of time between release of the first key and depression of the second key, sometimes referred to as a keyup-keydown time. Moreover, a pattern may include an amount of elapsed time between depression of the first key and the second key based on a distance on the keyboard between the first key and the second key, sometimes referred to as the flight length. In various examples, the processor 102 may block access of the second peripheral device 106-N in response to the comparison indicating that the particular input data has a high probability of being malicious.

As illustrated and discussed above in connection with FIG. 1 and elsewhere in the instant disclosure, various circuit-based structure is disclosed for carrying out specific acts or functions, as may be recognized in the figures and related discussion. Whether depicted as a block, device, interface, or apparatus (for example), such circuit-based structure refers to or includes circuitry designed to carry the acts or functions as so described. As specific examples of such circuit-based structure, among others, reference may be made to elements 100, 102, 104, and 106 of FIG. 1.

As an example, as an individual user interacts with their computing apparatus 100, the processor 102 learns what is normal for that user by constantly learning the manner in which the user interacts with the peripheral device. The longer the user interacts with the computing apparatus 100, the processor 102 may improve in detecting abnormal behavior. When a malicious peripheral device is plugged into the computing apparatus 100 and begins inputting keyboard (or other input) data, the processor may detect the low probability that the input data is coming from the user and may block the data from reaching the operating system of the computing apparatus 100. The processor may detect the low probability by comparing the input data received from the (new) peripheral device, with historic data relating to usage of the peripheral device. By comparing these two samples, namely the input data from the new peripheral device and the historic data, the processor may identify the probability that the input data received from the (new) peripheral device is similar to the training set.

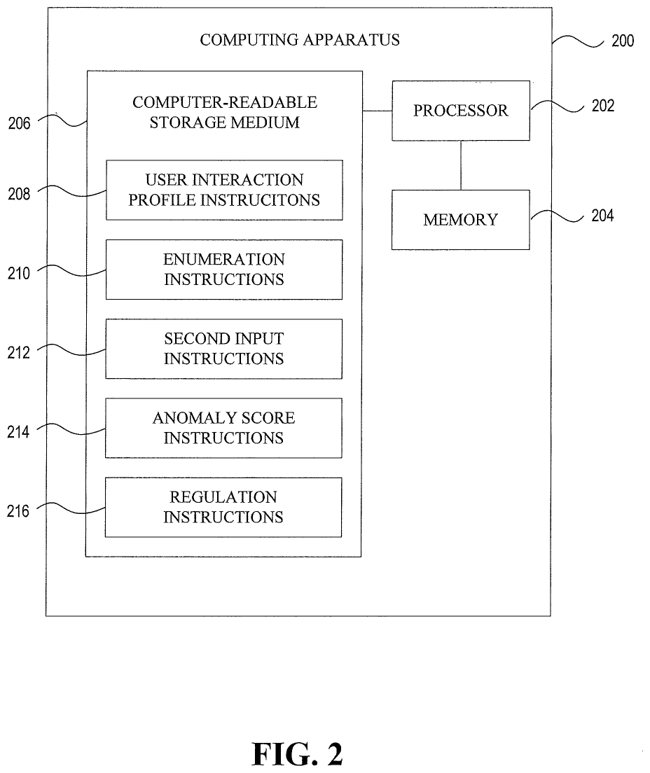

FIG. 2 illustrates a block diagram of an example computing apparatus 200 including instructions for access regulation of peripheral devices, consistent with the present disclosure. The computing apparatus 200 may include a processor 202, a computer-readable storage medium 206, and a memory 204.

The processor 202 may be a central processing unit (CPU), a semiconductor-based microprocessor, and/or other hardware devices suitable for access regulation of peripheral devices. The computer-readable storage medium 206 may be an electronic, magnetic, optical, or other physical storage device that contains or stores executable instructions. Thus, computer-readable storage medium 206 may be, for example, Random Access Memory (RAM), an Electrically Erasable Programmable Read-Only Memory (EEPROM), a storage device, an optical disc, etc. In some examples, the computer-readable storage medium 206 may be a non-transitory storage medium, where the term ‘non-transitory’ does not encompass transitory propagating signals. As described in detail below, the computer-readable storage medium 206 may be encoded with a series of executable instructions 208-216. In some examples, computer-readable storage medium 206 may implement a memory 204 to store and/or execute instructions 208-216. Memory 204 may be any non-volatile memory, such as EEPROM, flash memory, etc.

As illustrated, the computer-readable storage medium 206 may store instructions that, when executed, cause the computing apparatus 200 to perform a number of different operations for access regulation of peripheral devices. For instance, the computer-readable storage medium 206 may store user interaction profile instructions 208 that, when executed, cause the computing apparatus 200 to generate a user interaction profile including a feature representative of a manner in which first input data from a first peripheral device of the computing device is received. For instance, the user interaction profile may include a pattern in which a user types on a keyboard, an amount of pressure that the user typically uses when typing on particular keys on a virtual or physical keyboard, an amount of pressure a user typically applies when using a mouse, among other features. As used herein, a feature refers to or includes an aspect of interaction with a peripheral device such as a keyboard, a mouse, a touch screen, or other interactive devices. A collection of features may be referred to herein as a pattern.

The computer-readable storage medium 206 may, in some examples, store enumeration instructions 210 that, when executed, cause the computing apparatus 200 to detect enumeration of a second peripheral device coupled to the computing device. The computer-readable storage medium 206 may, in some examples, store second input instructions 212 that, when executed, cause the computing apparatus 200 to collect second input data from the second peripheral device, where the second input data includes second feature representative of a manner in which the second input data is received from the second peripheral device. For instance, referring to FIG. 1, the computing apparatus may collect input data from peripheral device 106-N.

The computer-readable storage medium 206 may, in some examples, store anomaly score instructions 214 that, when executed, cause the computing apparatus 200 to generate an anomaly score based on a comparison of the second input data and the user interaction profile. For instance, a plurality of model vectors representative of the user interaction profile may be generated, as well as a test vector from the second input data. A nearest-neighbor distance may be calculated between each respective model vector and the test vector, and the anomaly score may be generated based on the distances between the test vector to the nearest model vector. For instance, the processor 202 may save a list of model vectors and calculate a co-variance matrix. The processor 202 may calculate the distance between each of the model vectors and the test vector. An anomaly score may be calculated as the distance from the test vector to the nearest model vector.

The computer-readable storage medium 206 may, in some examples, store regulation instructions 216 that, when executed, cause the computing apparatus 200 to regulate input of the second peripheral device based on the anomaly score. For instance, the processor 202 may cancel the input data received from the second peripheral device, responsive to the anomaly score exceeding a particular value. Additionally and/or alternatively, the processor 202 may generate a display, such as a pop-up message on a graphical user interface of the computing apparatus 200, indicating that the input data from the second peripheral device appears malicious.

In various examples, the user interaction profile includes a plurality of features representative of the manner in which the first input data is received. In such examples, the instructions to generate the anomaly score may further include instructions to determine for each of the plurality of features, a respective mean vector and a respective mean absolute deviation. For instance, in a training phase, the mean vector of each feature is calculated, and the mean absolute deviation of each feature is calculated as well. In a test phase, the anomaly score may be calculated according to the following equation:

$${\sum }_{i = 1}^{p} \frac{\vert {x}_{i} - {y}_{i} \vert}{{a}_{i}}$$

where x(i) and y(i) are the i−n features of the test and model vectors respectively, and a(i) is the average absolute deviation from the training phase.

In some examples, the instructions to compare the input data include instructions to generate a plurality of training vectors based on the first input data, and block access of the second peripheral device responsive to a determination that the test vector differs from the plurality of training vectors my more than a threshold amount. For instance, the processor 202 may incorporate a fee-forward neural-network created during the training phase, in which input data from the first peripheral device is received and analyzed for various features. The training phase teaches the neural-network to produce output vectors close to the inputs for the training vectors. Then, during the test phase, in which data input from the second peripheral device is evaluated to determine if the second peripheral device is malicious, input vectors from the second peripheral device that produce dissimilar outputs are assigned high anomaly scores.

In various examples, the user interaction profile instructions 208 include instructions to collect feature information each time the user types and/or interacts with the peripheral device. The processor 202 may populate the model with the training data set. After a certain period of time, when the new keystroke information that is being passed to the processor stops helping the construction of the model, such that the difference between the output O(1) from the previous calculated output O(n−1) is smaller than a given threshold, the model is considered ready to process any keystroke information. As such, when the user is interacting with a peripheral device, the processor may present an anomaly score, which translates to a confidence level on whether a human was interacting with the peripheral device.

When a new peripheral device attempts to send input data, such as keyboard data, an anomaly score may indicate a high probability that the keyboard events from the new peripheral device don't belong to the user, because the feature set from the new peripheral device does not match the training data set. With this output, the processor 202 may cancels the keyboard events, via regulation instructions 216, thereby avoiding the modification of the computing apparatus 200.

In various examples, the typing samples of a single user may be used to build, or train, a model of the user's typing behavior. When a new typing sample is presented to the processor 202, the processor 202 compares the similarity of the new sample to the model, and outputs an anomaly score. With the anomaly score, the processor 202 may filter input data with a low probability of being user data. The processor 202 may also communicate blocked input data to the user, such that the user may manually override the blocked data in the event that another person using the computing apparatus 200.

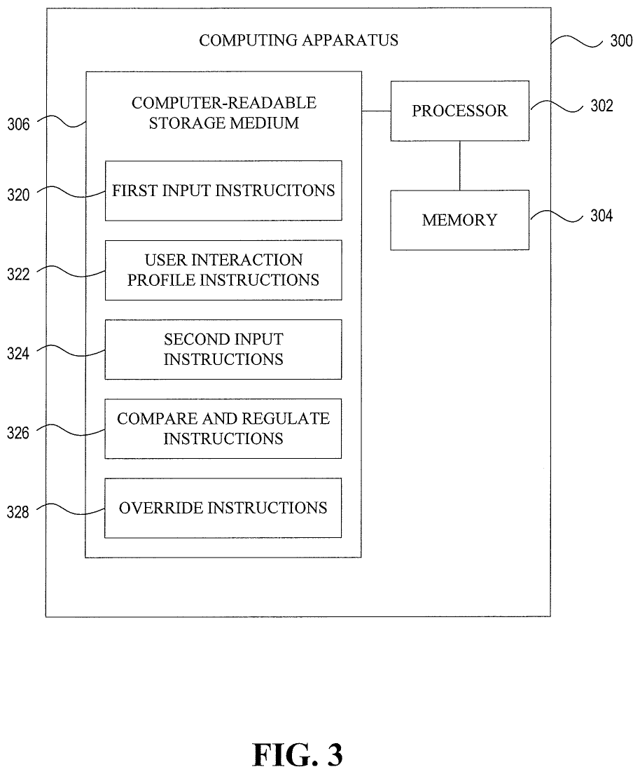

FIG. 3 illustrates a block diagram of an example computing apparatus 300 including instructions for access regulation of peripheral devices, consistent with the present disclosure. The computing apparatus 300 may include a processor 302, a computer-readable storage medium 306, and a memory 304.

Similar to processor 202 illustrated in FIG. 2, the processor 302 may be a central processing unit (CPU), a semiconductor-based microprocessor, and/or other hardware devices suitable for access regulation of peripheral devices for access regulation of peripheral devices. Similar to computer-readable storage medium 206 illustrated in FIG. 2, computer-readable storage medium 306 may be an electronic, magnetic, optical, or other physical storage device that contains or stores executable instructions. Thus, computer-readable storage medium 306 may be, for example, Random Access Memory (RAM), an Electrically Erasable Programmable Read-Only Memory (EEPROM), a storage device, an optical disc, etc. In some examples, the computer-readable storage medium 306 may be a non-transitory storage medium, where the term ‘non-transitory’ does not encompass transitory propagating signals. As described in detail below, the computer-readable storage medium 306 may be encoded with a series of executable instructions 320-328. In some examples, computer-readable storage medium 306 may implement a memory 304 to store and/or execute instructions 320-328. Memory 304 may be any non-volatile memory, such as EEPROM, flash memory, etc.

As illustrated, the computer-readable storage medium 306 may store instructions that, when executed, cause the computing apparatus 300 to perform a number of different operations for access regulation of peripheral devices. For instance, the computer-readable storage medium 306 may store first input instructions 320 that, when executed, cause the computing apparatus 300 to collect first input data from a first peripheral device coupled to the computing device, where the first input data includes a feature representative of a manner in which first input data from the first peripheral device is received. In some examples, the feature includes a pattern of keystroke entries. Additionally and/or alternatively, the feature may include a pattern of usage of a physical or a virtual mouse.

Additionally, the computer-readable storage medium 306 may store user interaction profile instructions 322 that, when executed, cause the computing apparatus 300 to generate a user interaction profile including the feature. Second input instructions 324, when executed, cause the computing apparatus 300 to collect second input data from a second peripheral device coupled to the computing device, where the second input data includes a second feature representative of a manner in which the second input data is received from the second peripheral device.

Compare and regulate instructions 326, when executed, may cause the computing apparatus 300 to, based on a comparison of the second input data and the user interaction profile, regulate access of the second peripheral device to the computing device. For instance, the computing apparatus 300 may generate an anomaly score based on the comparison, and identify the second peripheral device as a malicious device responsive to the anomaly score being above a threshold level. Override instructions 328, when executed, may cause the computing apparatus 300 to provide selectable options on a graphical user interface of the computing device to override regulated access of the second peripheral device, as discussed herein.

In some examples, the computer-readable storage medium 306 includes instructions that, when executed, cause the computing apparatus 300 to collect additional input data from the first peripheral device, and update the user interaction profile responsive to an indication that the additional input data differs from the user interaction profile by more than a threshold amount. For instance, input data may be gathered to build a user interaction profile, and collection of the input data may stop when the difference between the user interaction profile and the input data does not differ. As such, the computing apparatus 300 may stop collecting input data from the first peripheral device responsive to an indication that the additional input data does not differ from the user interaction profile by more than a threshold amount.

What is claimed is:

1. An apparatus, comprising:
a processor; and
a communication interface to communicate to a peripheral device and to the processor;
wherein the processor is to:
identify a pattern associated with receiving input data from a first peripheral device, wherein the pattern includes a keystroke rate, a delay in a keystroke pattern, a keystroke pressure, or a combination thereof;
in response to detecting enumeration of a second peripheral device coupled to the apparatus, compare particular input data received from the second peripheral device with the pattern; and
regulate access of the second peripheral device to the apparatus, based on the comparison.

2. The apparatus of claim 1, wherein the first peripheral device includes a keyboard, and the delay in the keystroke pattern includes a length of time between press and release of each respective key on the keyboard.

3. The apparatus of claim 1, wherein the first peripheral device includes a keyboard, and the pattern further includes:
an amount of elapsed time between depression of a first key on the keyboard and depression of a second key on the keyboard;
an amount of time between release of the first key and depression of the second key; or
an amount of elapsed time between depression of the first key and the second key based on a distance on the keyboard between the first key and the second key.

4. The apparatus of claim 1, wherein the processor is to block access of the second peripheral device in response to the comparison indicating that the particular input data has a high probability of being malicious.

5. A non-transitory computer-readable storage medium comprising instructions that when executed by a processor of a computing device, cause the processor to:
generate a user interaction profile including a feature representative of a manner in which first input data from a first peripheral device of the computing device is received;
detect enumeration of a second peripheral device coupled to the computing device;
collect second input data from the second peripheral device, wherein the second input data includes second feature representative of a manner in which the second input data is received from the second peripheral device;
generate an anomaly score based on a comparison of the second input data and the user interaction profile; and
regulate input of the second peripheral device based on the anomaly score.

6. The non-transitory computer-readable storage medium of claim 5, wherein the instructions to compare the input data include instructions to:
generate a plurality of model vectors representative of the user interaction profile;
generate a test vector from the second input data;
for each respective model vector, calculate a nearest-neighbor distance between the model vector and the test vector; and
generate the anomaly score based on the distances between the test vector to the nearest model vector.

7. The non-transitory computer-readable storage medium of claim 5, wherein the user interaction profile includes a plurality of features representative of the manner in which the first input data is received, and the instructions to generate the anomaly score further include instructions to:
determine for each of the plurality of features, a respective mean vector and a respective mean absolute deviation.

8. The non-transitory computer-readable storage medium of claim 7, further including instructions that when executed, cause the processor to generate the anomaly score using the mean vectors and the mean absolute deviations.

9. The non-transitory computer-readable storage medium of claim 6, wherein the instructions to compare the input data include instructions to:
generate a plurality of training vectors based on the first input data; and
block access of the second peripheral device responsive to a determination that the test vector differs from the plurality of training vectors my more than a threshold amount.

10. A non-transitory computer-readable storage medium comprising instructions that when executed by a processor of a computing device, cause the processor to:
collect first input data from a first peripheral device coupled to the computing device, wherein the first input data includes a feature representative of a manner in which first input data from the first peripheral device is received;
generate a user interaction profile including the feature;
collect second input data from a second peripheral device coupled to the computing device, wherein the second input data includes a second feature representative of a manner in which the second input data is received from the second peripheral device;
based on a comparison of the second input data and the user interaction profile, regulate access of the second peripheral device to the computing device; and
provide selectable options on a graphical user interface of the computing device to override regulated access of the second peripheral device.

11. The non-transitory computer-readable storage medium of claim 10, wherein the feature includes a pattern of keystroke entries.

12. The non-transitory computer-readable storage medium of claim 10, further including instructions that when executed, cause the processor to:
collect additional input data from the first peripheral device; and
update the user interaction profile responsive to an indication that the additional input data differs from the user interaction profile by more than a threshold amount.

13. The non-transitory computer-readable storage medium of claim 12, further including instructions that when executed, cause the processor to:
stop collecting input data from the first peripheral device responsive to an indication that the additional input data does not differ from the user interaction profile by more than a threshold amount.

14. The non-transitory computer-readable storage medium of claim 10, wherein the feature includes a pattern of usage of a physical or a virtual mouse.

15. The non-transitory computer-readable storage medium of claim 10, further including instructions that when executed, cause the processor to:
generate an anomaly score based on the comparison; and
identifying the second peripheral device as a malicious device responsive to the anomaly score being above a threshold level.
